(19) United States
(12) Patent Application Publication
(10) Pub. No.: US 2005/0182669 A1
(43) Pub. Date: Aug. 18, 2005

(54) Supplemental rating and financial review questionnaire

(75) Inventors: Paul Tinnirello, Flemington, NJ (US); Arthur Snyder III, Lebanon, NJ (US)

Correspondence Address: MORRISON & FOERSTER LLP, 1650 TYSONS BOULEVARD, SUITE 300, MCLEAN, VA, 22102, US

(73) Assignee: A.M BEST COMPANY, INC., New Jersey, NJ (US)

(21) Appl. No.: 11/060,572

(22) Filed: Feb. 17, 2005

Related U.S. Application Data
(60) Provisional application No. 60/545,132, filed on Feb. 18, 2004.

(51) Int. Cl. G06F 17/60

(52) U.S. Cl. 705/4; 707/3

(57) ABSTRACT

The invention relates to a system and method for collecting data for use in rating systems. In a preferred embodiment, the invention includes a standardized supplemental rating and financial review questionnaire (SRQ) for completion by an insurance company. The SRQ provides detail on each insurer's business and investment risks, as well as information on insurance claims and reserves. The SRQ is one of several elements used to assign a financial strength rating to the insurance company. This rating provides a reliable, objective means of indicating the financial strength and performance of insurance companies.

### CROSS-REFERENCE TO RELATED APPLICATIONS

This application claims the benefit of U.S. Provisional Application No. 60/545,132, filed Feb. 18, 2004, which is hereby incorporated by reference in its entirety.

### FIELD OF THE INVENTION

The invention relates to a software system for completing, analyzing, and submitting financial data by insurance companies. The system determines whether the data is completed in accordance with the requirements of an independent insurance-industry services provider, such as the A.M. Best Company. The invention performs numerous verification checks to ensure that required input maintains data integrity, and submits the data through electronic means to meet the insurance company's filing criteria for the purposes of financial analysis and for use within the rating process of the services provider.

### BACKGROUND OF THE INVENTION

Each year, domestic, Canadian, and international insurance companies, cooperating with independent insurance-industry services providers such as the A.M. Best Company (AMB), complete a standardized supplemental rating and financial review questionnaire (SRQ). The SRQ provides detail on each insurer's business and investment risks, as well as information on insurance claims and reserves. The SRQ is one of several elements used by AMB to assign a Best's Financial Strength Rating to the insurance company, a rating that is well-known to those familiar with the insurance industry. This rating is recognized throughout the insurance industry as a reliable, objective means of indicating the financial strength and performance of insurance companies.

The SRQ requests information that supplements and/or complements the content and scope of the statutory filing required by the National Association of Insurance Commissioners (NAIC) for domestic companies, Office of the Superintendent of Financial Institutions (OSFI) for Canadian companies, and the corresponding insurance-industry regulatory authorities for international companies. Additionally, the SRQ information may be used in conjunction with U.S. Securities and Exchange Commission filings of insurance-industry financial data. AMB publishes detailed and extensive instructions for the completion and filing of these questionnaires electronically.

It is important to understand that the A.M. Best Company does not perform any auditing services with regard to financial disclosures of the insurance industry. It is expected that the information provided is accurate as attested by the officers of the insurance company and in the manner prescribed by the regulatory authority.

For purposes of the present disclosure, the use of the SRQ will be described by way of example, using the A.M. Best Company's procedures. Those skilled in the art will readily recognize that the disclosed software system can be adapted for use by most any independent insurance-industry services provider or software provider. As such, the A.M. Best Company develops questionnaire software each year in accordance with its proprietary conventions. This software is used by the insurance industry to complete supplementary financial data, verify its reasonableness within specifications, and submit the financial information to the A.M. Best Company.

The AMB conventions that are embodied in the software include:
Forms that comprise the questionnaire, which are organized into interrogatories, tables, and descriptive information
Type of information to be reported on the forms, including numeric, textual, date, precision, length, and other attributes
Crosscheck formulas that test the mathematical and logical interrelationships of amounts and text both within and among forms.
Specifications to convert the information reported on the forms into an electronic format.
Printed output of the completed questionnaire and audit control management reports in Portable Document Format (PDF) or other electronic image format, or a hard copy version.
Assembly of the component information into an electronically secured file format that may include compression and/or encryption.
Submission of the secured electronic file to AMB via the Internet, on diskette or CD/DVD-ROM, or by other electronic means.

The major goals of the electronic filing conventions are increasing the quality of data in the SRQ and achieving timely submission compliance by each insurance company.

### SUMMARY OF THE INVENTION

In an illustrative embodiment, the invention relates to a method for collecting data and, in a preferred embodiment, insurance industry-related data or insurance industry financial data.

A software-based rating and financial review questionnaire permits data entry at a user terminal. The software may be installed at the user terminal or present on a host server. Alternatively, components of the software may be present in various locations and initialized or loaded as necessary.

The software facilitates the entry of data, such as insurance industry-related data and/or insurance industry financial data. For example, a first datum may be entered in response to a first query and a second datum may be entered in response to a second query. To determine whether the data entered by the user is reasonable, crosschecking may occur. In order to crosscheck the first and second data, it should be determined whether the data conform to certain specifications. If the data conforms to such specification, as described in step 420 of the FIG. 1, then the data is deemed “accurate”. This should not be construed to mean the data entered by the user is correct, merely that the information requested by the software is consistent and within the parameters expected for such data. Only the end user can accurately determine whether the data being entered is, in fact, correct. The present software system, however, determines whether the first and second data are accurate by determining whether the first and second data have a relationship that conforms to a prescribed formula.

If the data is not accurate, the software may access a failure explanation file. The user may then receive a report or other notice indicating what data is not in accordance with the prescribed relationship. Alternatively, missing data or data in an incorrect format could be deemed to be inaccurate by the present system.

Once crosschecking is complete and any failure messages have been rectified, the data is assembled. At least the first and second data are assembled into component files. An electronically secure data file comprising the component files may also be created and then transferred to a provider of host services.

The present method for collecting data may require establishing communication between a provider of host services and a user computer via network connection, such as the Internet or other distributed network. Once connected, the host services provider may access a data file that includes information previously received from the user computer by the provider of host services. In the situation where the software is installed locally at the user computer, the host may determine whether the user computer has a most recent version of a software program installed. If not, the host may execute a software program to update or install software on the user computer configured to collect data.

### BRIEF DESCRIPTION OF THE DRAWING FIGURES

FIG. 1 shows an illustrative flow chart of the software process of the present invention.

### DETAILED DESCRIPTION OF THE INVENTION

Overview of the Questionnaire Completion and Submission Process

Insurance companies are responsible for reporting the SRQ data in the manner prescribed by AMB as a part of the process to receive a comprehensive financial analysis and Best's Financial Strength Rating. The major steps in the questionnaire completion and submission process may be summarized as follows:
Insurance companies run a setup of the SRQ software on user workstations, network servers, Web services servers, or AMB host servers.
Company personnel assemble their financial information from a plurality of sources, including but not limited to, internal records, prior year SRQ filing software, AMB database servers, third-party software, and external parties, and in a plurality of formats, including but not limited to, paper, data files, graphics, word-processing documents, electronic spreadsheets, and PDF files or other electronic image files.
The financial information is incorporated into the questionnaire data using a plurality of methods, including but not limited to, data entry onto forms, importing data files, word-processing documents, or electronic spreadsheets, electronic scanning of paper documents, and copying externally created PDF files or other electronic image files.
Create a PDF file or other electronic image file, or a hard copy, of management reports that provide audit control for each step of the submission process.
Run crosscheck formulas to test and report the reasonableness of the data both within and among forms.
Correct invalid data as determined by the crosschecks that report failed results and run crosschecks iteratively until the failed results have been eliminated or acceptable failed results have been identified.
Explain each acceptable failed crosschecks result electronically in narrative form.
Record the questionnaire data in a format defined by an electronic filing specification.
Create a PDF file or other electronic image file of the completed questionnaire that conforms to an electronic filing specification.
Report the failed crosscheck results and their failure explanations in a file format defined by an electronic filing specification.
Assemble the questionnaire data, questionnaire PDF files or other electronic image file, crosscheck results file, and crosscheck failure explanation file into an electronically secured file that may include compression and/or encryption.
Submit the secured electronic file to the A.M. Best Company using a filing Web site, on diskette or CD/DVD-ROM, or by other electronic means.
Create a PDF or other electronic image copy, or print a hard copy, of the completed questionnaire to be retained for company records.
   The SRQ Concept

The SRQ is an extension application that can work in conjunction with the Insurance Data Uniform Submission Component (IDUSC), which is more fully described in commonly assigned, co-pending U.S. application Ser. No. 60/601635, which is hereby incorporated by reference in its entirety. Alternatively, the SRQ may operate as a stand-alone application on any system where the IDUSC is not available, or where the user does not wish to deploy the SRQ as an extension of the IDUSC. The SRQ setup can be run on each user workstation, network server, Web services server, or an AMB host server, and updated periodically and as necessary via the Software Support Center. A Web based setup is the preferable distribution method, but alternatives of CD/DVD-ROM, e-mail, or other electronic means, can be available for those users without Internet capability.

Access to data may include both single user and multi-user methods, employing a data locking scheme that is independent of the inherent data locking mechanisms of a database, operating system, or network protocol. In the single user method, the SRQ data is available to only one user at a time and is locked in its entirety. Another user may not gain access to any data until the current user exits from the SRQ application and releases all of the data locks. This method may be useful, for example, in a company where a limited number of users are authorized to complete the SRQ, or where there is restricted access to the data.

By contrast, in the multi-user method, two or more users on a network may share access to the same data by running multiple copies of the SRQ application. A single data element is locked by the first user who requests access to that element, and the element may be accessed by any other user only after the first user relinquishes the lock. All other unlocked data elements are available to any other user in a similar manner. The scope of data elements that may be locked by a user can vary considerably, including, but not limited to, a single data entry cell, an entire form, all forms, and various input and output files. The data locking scheme can ensure data integrity by preventing concurrent modification of a data element by multiple users. This method may be useful, for example, in a company where a workgroup of users shares the responsibility of completing the SRQ, or where there is broad access to the data.

The SRQ may include data entry forms, processes to import data files from external financial software applications, and procedures to incorporate external electronic and paper documents as data; audit control management reports, data testing, verification, and failure explanation procedures, data conversion with compression, PDF or other electronic image creation and hard copy printing capabilities, assembly of component files into an electronically secured file that may include compression and/or encryption, electronic media creation, and submission of the electronically secured file via the Internet, on diskette or CD/DVD-ROM, or by other electronic means; exporting questionnaire data for use in external software applications; and availability of AMB host servers to incorporate previously filed data, create insurance-industry analytical executive reports, and access on-line insurance-industry resources.

User interfaces for the various aspects of the submission are desirably kept to a minimum in order to automate the process as fully as possible. A user profile and submission checklist can specify the conditions of each submission to run the processes in the proper sequence and eliminate unnecessary user intervention. These conditions can include company type and due date, component files to be submitted, Internet or diskette filing preference, and numerous additional options. Audit control reports may also be generated as a PDF file or other electronic image file, or as a hard copy, to manage each step of the submission process.

Mechanisms may be provided to assure that all components of the submission have been created and assembled by the SRQ, and not by any external resources that produce electronic image files of the questionnaire and electronically secured files with compression and/or encryption. Indicators may be set at various stages, which can be interrogated by AMB systems, verifying that the sole source of the submission is the SRQ application. The filing could be rejected if these conditions have not been met.

The Innovative SRQ Architecture

The SRQ architecture employs an innovative model that defines the elements and processes as a set of distributed and decentralized services that are reusable by multiple applications. These services may exist anywhere on the network to maximize utilization of the network's characteristics, their location is transparent and immaterial to the user, and they perform specific, discrete functions. This approach offers distinct advantages for ensuring data integrity and security, including verifying and restricting personnel access, creating backup archives, off-site or hot-site warehousing, and encryption. The user is relieved of much of the ongoing activity of data management, and can instead focus on his core business without the added responsibility of system administration.

Traditional software development physically deploys programs, files, and support components of an application in one place and typically expects the input and output data to be available in that same location. For example, an installer program may copy programs, databases, and support files to a designated root folder with sub-folders on a workstation or network server, and the software may create new data files or incorporate data from external sources using another sub-folder under the same root folder on the same system. The user is required to understand this folder structure and features of the operating system to backup or restore files, retrieve information from a prior year, copy data files from a source location, or copy data files to a target location.

By contrast, the SRQ architecture of decentralized services does not require physical deployment of programs, files, and support components of an application on a user workstation or network server, but merely access to each service at its current host location. Furthermore, there is no requirement to locate programs, databases, and support files at any particular dedicated host or combination of hosts, only that those facilities be available when required. For example, the SRQ setup can enable host services at AMB via the Internet to present data entry screens, incorporate previously filed data, run crosscheck formulas, create the various electronic filing component files, transfer the electronically secured file to the AMB Data Submission Site, and perform backup operations, while allowing the user to store the data, component, electronically secured files, and backup files on a workstation or network server. Alternatively, the user could request the SRQ setup to enable selected services on company intranet or extranet servers with access to the Internet, while storing the data, component, electronically secured, and backup files on AMB servers. The user does not need to understand any folder or network structure or features of the operating system to backup or restore files, retrieve information from a prior year, copy data files from a source location, or copy data files to a target location.

Maximum flexibility and distribution of services are available when the user is connected to the Internet, taking full advantage of the AMB host services in conjunction with the user facilities. In the absence of an Internet connection, the SRQ setup can still enable the services architecture on an extranet, intranet, or peer-to-peer network, although with diminishing capabilities. Finally, running the SRQ setup on a stand-alone workstation without Internet access will disable all services and install the SRQ as a traditional application.

As an illustrative embodiment, the SRQ architecture is divided into several broad categories, each containing related types of services, which may include, but are not limited to:
AMB Host—services include, but are not limited to, Setup, Software Support Center, Previously Filed Data, Data Submission Site, Executive Reports, On-line Insurance Industry Resources
Questionnaire Completion—services include, but are not limited to, External Data, Data Entry, Crosscheck, Failure Explanation, Management Reports
Printing—services include, but are not limited to, Electronic Image Copy, Hard Copy
Filing Component—services include, but are not limited to, Questionnaire Data File, Crosscheck Results File, Failure Explanation File, Electronic Image File, Single Secured File
Submission—services include, but are not limited to, Data Submission Site Transfer, CD Creation, Diskette Creation
Data Export—services include, but are not limited to, AMB Export, XML Export, XBRL Export, Excel Export
Security—services include, but are not limited to, Compression, Encryption, Authentication, Single User/Multi-User Data Access, Backup/Restore
   Advantages of the SRQ Design

The SRQ advantages for the insurance industry and AMB are the following:
The SRQ services approach creates a flexible, scalable architecture that utilizes workstations, network servers, Web services servers, and AMB host servers in a distributed environment and to maximum advantage.
The distributed services relieve the user of much of the ongoing activity of data management, and allow the user to instead focus on his core business without the added responsibility of system administration.
It attempts to minimize the interaction between the end user and the submission process by encapsulating all of the functionality in a series of automated steps. The user should be concerned primarily with completing the data and filing it by the due date with the A.M. Best Company, and not the technical basis of creating an electronic submission by running discrete processes.
The electronic image technology implemented in the SRQ produces efficiently compressed and organized files. Files that are consistently optimized for Internet viewing are available for analysis and printing more readily, and are less wasteful of communication bandwidth.
For users with Internet capability, timely software updates can be provided via the Software Support Center as an automatic service for user workstations, network servers, Web services servers, or AMB host servers, eliminating the need to manually install periodic and potentially outdated updates by CD/DVD-ROM, e-mail, or other electronic means. Variations in data submission arising from differing software versions can be minimized.
   Illustrative Overview of the SRQ Model

As an illustrative embodiment, the SRQ model is divided into several broad areas of functionality, as follows:
100 Series—SRQ setup is run on user workstations, network servers, Web services servers, or AMB host servers, from a plurality of sources.
200 Series—AMB host servers and other facilities at AMB provide services via the Internet.
300 Series—SRQ optionally accesses previously filed data as available from AMB, and incorporates other external data into the questionnaire from a plurality of file formats.
400 Series—User completes the questionnaire data. SRQ analyzes the questionnaire data, provides audit control management reports, creates the electronic submission component files, assembles the submission in a plurality of methods, exports the completed questionnaire data in a plurality of file formats, and prints a hard copy for company records.
500 Series—User imports questionnaire data into a plurality of software applications.
600 Series—SRQ creates executive reports using the current questionnaire data and previously filed data as available from AMB, and accesses on-line insurance industry resources at AMB.
700 Series—SRQ automatically transfers the secured electronic submission file to the AMB Data Submission Site if the user has Internet access, or the user manually sends the secured electronic submission file on diskette or CD/DVD-ROM, or by other electronic means, to AMB if Internet access is not available.
   Description of SRQ Flowchart

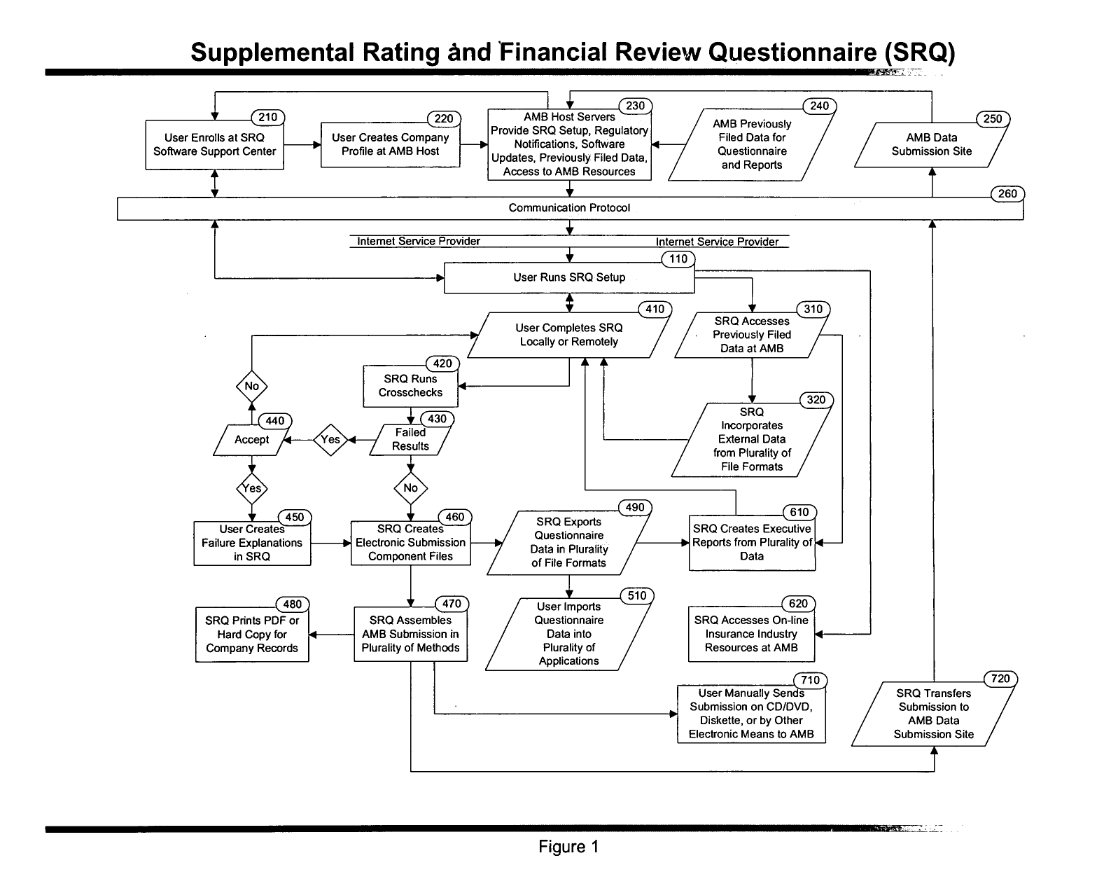

Following is a detailed description of the illustrative model embodied in the SRQ flowchart, shown in FIG. 1:
110—The SRQ software setup is run by the user, on any combination of workstations, network servers, Web services servers, or AMB host servers. The SRQ may be run as an integrated extension of the IDUSC software, or as a stand-alone application on any system where only the SRQ will be completed. The preferred setup method will be to run the Web based process from an AMB host at (230) via Internet browser software that connects to the Software Support Center at (210). After completing the enrollment procedure at (210), the company profile at (220), and the SRQ setup at (230), the AMB host services will be available. Ongoing communication between the user and the AMB host services will be provided via the Software Support Center. Alternative CD/DVD-ROM, e-mail, or other electronic setups will be available for users without Internet capability, but these would not provide access to the AMB host services.
The SRQ may be configured to transmit information over an open network such as the Internet, a peer-to-peer local area network such as Microsoft Networking, an intranet, extranet, or other wide area network, a mobile device such as Blackberry, or any combination, using communication protocols that can include, but are not limited to, TCP/IP, FTP,.HTTP, and SSL.
210—The user enrolls at the SRQ Software Support Center for online software support and other AMB host services. Enrollment involves establishing traditional mailing and electronic contact information, and creating an account number and security profile. The enrollment information will be used to provide ongoing Web based support for the SRQ and the data submission process. The Software Support Center will be the portal by which the SRQ communicates between the user and the AMB host services.
220—The user supplements (210) by additionally creating a company profile at an AMB host. The profile will define the operating environment of the user, including workstations, network servers, Web services servers, AMB host servers, communication facilities, types of services, file locations, and other preferences. The types and frequency of e-mail broadcast notifications and automated software updates the user wishes to receive, and access to previously filed data, executive reports, and AMB on-line insurance industry resources, will be customized. The profile will also control the transfer of data to the AMB Data Submission Site at (250).
230—AMB host servers provide the Web based setup for the SRQ, periodic regulatory notification by e-mail, automated software updates, previously filed data, analytical executive reporting, access to AMB on-line insurance industry resources, and transfer acknowledgements for data received at (250). The type and frequency of these communications will be based upon the information provided at (210) and (220).
240—The SRQ accesses the AMB corporate database servers to provide previously filed data for the SRQ completion at (310). The type of data available to the user is based upon the information provided at (220).
250—The AMB Data Submission Site is a dedicated server that receives transfers of electronically secured files from the SRQ at (720), based upon the information provided at (220). Verification and acknowledgement of these transfers are sent to the user at (230).
260—Communication between the user and AMB host services is conducted via the Internet using protocols that can include, but are not limited to, TCP/IP, FTP, HTTP, and SSL. The user must make arrangements with an Internet Service Provider to install the appropriate communication capability, which may include, but is not limited to, dialup, DSL, cable, T1, or WiFi.
310—The SRQ accesses the AMB corporate database servers at (240) to provide previously filed data for the SRQ completion at (410). The type of data available to the user will be based upon the information provided in the company profile at (220).
320—SRQ incorporates external questionnaire data from a plurality of file formats. These file formats can include, but are not limited to, previous year SRQ data files, AMB data file import specifications, PDF files or other electronic image files, electronically scanned paper documents, Excel spreadsheet files, and databases incorporating XML, XBRL, or other mark-up languages.
410—The user completes the SRQ data from a plurality of current year and previously filed sources. These sources can include, but are not limited to, manual entry from company records, external PDF files or other electronic image files, electronic scanning of paper documents, electronic spreadsheets, and AMB database servers at (310). The plurality of data files may reside on user workstations, network servers, Web services servers, AMB host servers, or any combination. Audit control reports may also be generated as a PDF file or other electronic image file, or as a hard copy, to manage each step of the questionnaire completion and submission process. The results that are reported may include, but are not limited to, incorporating external data, running crosschecks, creating and assembling the electronic submission files, or transferring the electronic submission to AMB,
420—SRQ runs AMB crosscheck formulas to test and report the reasonableness of the data. A typical crosscheck of a submission may comprise a large number of computations, each requiring the evaluation of many mathematical formulae, in order to ensure that the data entered in the SRQ conforms to expected guidelines. A large submission, for example, may require hundreds of thousands of calculations to crosscheck. Crosscheck formula characteristics may include, but are not limited to, single or multiple mathematical and logical operators within each formula, individual or combination testing of inter-page and intra-page data, single or multiple testing steps within each formula, and dollar or percentage tolerances that define an allowable deviation from a target amount. Whenever crosscheck formula revisions or enhancements for the current year are required, they may be accessed via the Software Support Center at (210).
430—SRQ reports the results of running the AMB crosschecks, and indicates whether any crosscheck results have failed. Failed crosscheck results will require additional analysis by the user at (440), while an absence of failed results will allow the user to create the electronic submission component files at (460).
440—The user must analyze each failed crosscheck result for its validity. The majority of failed results will be unacceptable, due primarily to inconsistent questionnaire data, which must be corrected at (410). However, crosscheck results may justifiably fail due to business exceptions, or because the AMB crosscheck formula needs revision. In these acceptable instances, the user must create an explanation for the failed crosscheck result at (450).
450—SRQ provides the ability for the user to create an electronic narrative explanation for any failed crosscheck result that is identified as acceptable. The user can not create the electronic submission component files at (460) until all failed crosscheck results have been explained in this manner. The user will perform (410) through (450) iteratively until all unacceptable failed crosscheck results have been corrected and all acceptable failed crosscheck results have been explained.
460—The SRQ creates the component files required by the AMB electronic submission conventions. These components can include, but are not limited to, questionnaire data in a plurality of file formats, PDF or other electronic image file of the completed questionnaire, and crosscheck results and failed crosscheck explanation files. Various compression algorithms may be used for efficiency with different file types, and can include, but are not limited to, Zip for data, JPEG or GIF for images, PDF for documents, and MPEG or WAV for streaming media.
470—The SRQ assembles the component files into a single electronically secured file with compression and/or encryption in a plurality of methods for submission to AMB. These methods can include, but are not limited to, storing the file on a user workstation, network server, Web services server, or an AMB host server, for eventual Internet transfer to the AMB Data Submission Site at (720), and copying the file to diskette or CD/DVD-ROM, or other electronic means, to send to AMB at (710). A compression algorithm for this file can include, but is not limited to, a Zip archive. Encryption may be accomplished using commercially available 128-bit or higher software, and additional security and authentication can include, but is not limited to, VeriSign, Thawte, or similar management services.
480—The SRQ creates a PDF other electronic image copy, or prints a hard copy, of the completed questionnaire to be retained for company records.
490—SRQ exports the completed questionnaire data in a plurality of file formats for import into a plurality of applications at (510) and for use with executive reports at (610). These file formats can include, but are not limited to, AMB data file export specifications, PDF files or other electronic image files, Excel spreadsheet files, and databases or other data structures incorporating XML, XBRL, or other mark-up languages.
510—User imports SRQ data into a plurality of external applications. These applications can include, but are not limited to, general ledger systems, Excel spreadsheets, tax preparation systems, and corporate databases.
610—SRQ creates executive reports from a plurality of data sources that are customized by the company profile, including, but not limited to, current year questionnaire data and previously filed information from AMB corporate database servers. These reports can include, but are not limited to, analysis by peer companies, groups of companies, or industry segments.
620—SRQ accesses on-line insurance industry resources at AMB. These resources can include, but are not limited to, daily, weekly, and monthly news publications, statistical studies, and rating methodology. The type of resources available to the user will be based upon the information provided in the company profile at (220).
710—The user sends the electronically secured file on diskette or CD/DVD-ROM, or by other electronic means, to AMB by mail or other delivery service. Sending the electronically secured file by these methods supercedes transferring the file to the AMB Data Submission Site at (720).
720—The SRQ connects to the AMB Data Submission Site via the Internet, identifies and locates on a user workstation, network server, Web services server, or AMB host server, the required electronically secured file to be submitted, and transfers the selection. Transferring the electronically secured file by this method supercedes sending the file on diskette or CD/DVD-ROM, or by other electronic means, at (710).

The present disclosure relates to a preferred embodiment of the present invention and is applicable to a wide variety of uses within the insurance industry. For example, although insurance-industry financial data is used throughout the examples and description, the invention may include the use of insurance-related data generally and not merely be limited to the embodiments described herein.

1. A method for collecting data, comprising:
initializing a software-based insurance industry-related questionnaire to permit data entry at a user terminal;
entering a first insurance industry-related datum in response to a first query;
entering a second insurance industry-related datum in response to a second query;
crosschecking the first and second insurance industry-related data;
determining whether the first and second insurance industry-related data are accurate, wherein the accuracy of the first and second insurance industry-related data is determined by whether the first and second insurance industry-related data have a relationship that conforms to a prescribed formula;
accessing a failure explanation file if the first and second insurance industry-related data are not accurate;
assembling at least the first and second insurance industry-related data into component files if the first and second insurance industry-related data are accurate;
creating an electronically secure data file comprising the component files;
transferring the data file to a provider of host services.

2. The method of claim 1 wherein the software-based insurance industry-related questionnaire is configured to be accessed via the user computer.

3. The method of claim 2 wherein the user computer communicates with a provider of host services via a distributed network.

4. The method of claim 3 comprising downloading software components to the user computer from the provider of host services.

5. The method of claim 4 comprising enrolling a user on the provider of host services and providing software support to the user, the software support comprising product updates, product news, customized user-specific information, and combinations thereof.

6. The method of claim 1 wherein the secure data file is encrypted and/or compressed.

7. The method of claim 1 wherein the secure data file is transferred to the provider of host services via a network connection.

8. The method of claim 5 comprising automatically transmitting product updates to the user computer.

9. The method of claim 1 wherein the provider of host services comprises at least one server for receiving at least one secure data file from at least one user computer.

10. The method of claim 9 comprising transmitting a verification and/or acknowledgement from the host to the user computer when a secure data file is received by the host.

11. The method of claim 1 wherein the insurance industry-related data comprises insurance data, financial data, data that is requested in response to a requirement of law or industry regulation, or combinations thereof.

12. A method for collecting insurance industry-related data, comprising:
establishing communication between a provider of host services and a user computer via network connection;
accessing a data file including information previously received from the user computer by the provider of host services;
determining whether the user computer has a most recent version of a software program installed;
optionally executing a software program to update or install software on the user computer configured to collect insurance industry-related data;
collecting more than one insurance industry-related datum;
determining whether the insurance industry-related data entered into the software program is consistent by crosschecking at least one datum with at least one other datum, wherein insurance industry-related datum are considered to be consistent when they conform to a prescribed relationship;
accessing a failure explanation file if the insurance industry-related data is not consistent and generating a failure explanation message;
assembling the insurance industry-related data into component files if the rating data are consistent;
creating a data file comprising the component files;
transferring the data file to the provider of host services.

13. The method of claim 12 wherein the data file is encrypted and/or compressed.

14. The method of claim 12 wherein the data file is forwarded to an originator of the questionnaire on a CD-ROM, DVD, floppy diskette, hard disk drive, or tape cartridge.

15. The method of claim 12 wherein the data file is printed and forwarded to an originator of the questionnaire.

16. The method of claim 12 wherein the data file is transferred to the host server via the Internet.
